(19) United States
(12) Patent Application Publication
(10) Pub. No.: US 2014/0364527 A1
(43) Pub. Date: Dec. 11, 2014

(54) LOW-VISCOSITY REACTIVE POLYURETHANE COMPOUNDS

(71) Applicant: Bayer Intellectual Property GmbH, Monheim (DE)

(72) Inventors: Matthias Wintermantel, Hürth (DE); Eduard Mayer, Dormagen (DE); Peter Reichert, Dormagen (DE)

(21) Appl. No.: 14/366,300

(22) PCT Filed: Dec. 18, 2012
(86) PCT No.: PCT/EP2012/075917

§ 371 Date: Jun. 18, 2014

(30) Foreign Application Priority Data
Dec. 23, 2011 (DE) 10 2011 089 783.6

(51) Int. Cl. C08G 18/76; C08G 18/32; C08G 18/48

(52) U.S. Cl. CPC C08G 18/7671; C08G 18/4825; C08G 18/3206
USPC 521/174; 528/77

(57) ABSTRACT

The present invention relates to a method for the production of low-viscosity polyurethane prepolymers (PUR prepolymers) based on 2,4′-MDI, as well as the use of said polyurethane prepolymers.

The present invention relates to a method for the production of low-viscosity reactive polyurethane compositions and to the use thereof in reactive one- and two-component adhesives/sealants, reactive hot melt adhesives, bonding foams, encapsulating compounds and in flexible, rigid and structural foams.

Reactive polyurethanes have reactive end groups, which can react with water or other compounds having an acidic hydrogen atom. This form of reactivity makes it possible to bring the reactive polyurethanes to the desired location in a processable state (generally liquid to highly viscous) in the desired manner and to cure them by adding water or other compounds having an acidic hydrogen atom (referred to in this case as a hardener).

In these so-called 2-pack systems, the addition of the hardener generally takes place immediately before application, normally with the aid of a mixing and metering system, there being only a limited processing time available to the processor after the hardener is added.

However, it is also possible to cure polyurethanes having reactive end groups without adding hardeners simply by reaction with atmospheric humidity (1-pack systems). These 1-pack systems generally have the advantage over the 2-pack systems that for the user, the often arduous mixing of the frequently viscous components prior to application becomes unnecessary.

The polyurethanes with reactive end groups generally used in 1-pack or 2-pack systems include e.g. the polyurethanes with preferably terminal isocyanate (NCO) groups.

To obtain polyurethanes with terminal NCO groups, it is customary to react polyfunctional alcohols with an excess of monomeric polyisocyanates, generally diisocyanates.

It is known that, at the end of the reaction, regardless of the reaction time, there remains a certain quantity of the monomeric diisocyanate that was used in excess.

A content of monomeric diisocyanate has a negative effect e.g. in the processing of reactive one- and two-component adhesives/sealants, reactive hot-melt adhesives, bonding foams, encapsulating compounds and in flexible, rigid and structural foams.

Even at ambient temperature, diisocyanates such as IPDI or TDI can exhibit a not insignificant vapour pressure. This noticeable vapour pressure is particularly serious in the case of spray application, since in this case significant quantities of isocyanate vapours can emerge through the application device, which are toxic because of their irritant and sensitising action. While sealants are generally processed at ambient temperature, the processing of adhesives often takes place at elevated temperature. For instance, the processing temperatures of hot-melt adhesives are between 100° C. and 200° C., and those of laminating adhesives are between 30° C. and 150° C. At these temperatures and with other specific application parameters, such as e.g. atmospheric humidity, the widespread bicyclic diisocyanates, for example, in particular diphenylmethane diisocyanates, form gas and aerosol emissions. The user is therefore subject to legal requirements specifying costly measures to protect the persons processing the product, in particular costly measures to maintain breathable air, through the maximum permissible concentration of working materials of gas, vapour or airborne particulates in the workplace annually updated list of MAK [maximum workplace concentration] values of technical regulation TRGS 900 of the German Federal Ministry for Labour and Social Affairs).

Since protective and cleaning measures are generally associated with high financial investment or costs, there is a need on the part of the user for products having the lowest possible content of monomeric diisocyanates.

However, it is not only applying reactive adhesives still comprising monomeric polyisocyanate that leads to problems, but even bringing them on to the market. Thus, since Jan. 12, 2010, substances and preparations comprising more than 1.0% free MDI must additionally be labeled with the R-phrase R40 (Limited evidence of a carcinogenic effect).

The presence of monomeric, unreacted starting diisocyanate often also leads to problems in further processing. For instance, monomeric diisocyanates can “migrate” out of the coating or bond and into the coated or bonded materials. These migrating components are often referred to in specialist circles as “migrants”. Through contact with moisture, the isocyanate groups of the migrants are continuously reacted to form amino groups and other metabolites.

In polyurethane structural foams, which are used e.g. in the production of steering wheels in motor vehicles, these migrants are undesirable since skin contact with the amines formed from the migrating diisocyanates cannot be ruled out.

In the packaging sector too, particularly in foodstuffs packaging, migrants are undesirable. On the one hand, the migration of the migrants through the packaging material can lead to contamination of the packaged product, and on the other hand, depending on the quantity of free monomeric diisocyanate capable of migrating, long waiting times are needed before the packaging material is “migrant-free” and may be used.

For the above-mentioned areas of application, therefore, the development of reactive polyurethanes and reactive one- and two-component adhesives/sealants, bonding foams, encapsulating compounds and flexible, rigid and structural foams based thereon having a drastically reduced content of monomeric diisocyanates is highly desirable.

One possible way of producing reactive polyurethanes with a reduced content of monomeric diisocyanates consists in reacting a diol component with a stoichiometric excess of monomeric diisocyanate to form a prepolymer and then freeing the prepolymer from the monomeric diisocyanate by distillation or by addition of a non-solvent for the high molecular weight diisocyanate.

This procedure has been state of the art for decades. Thus for example EP-A 1 241 197 describes the production of isocyanate functional prepolymers with low residual monomer content using a molecular evaporator. Preferred isocyanates are TDI, MDI, XDI, HDI and IPDI. The disadvantage of this method, however, is that in addition to the production of the prepolymer there is an additional costly process step, i.e. the separation of the excess monomeric isocyanates e.g. by distillation. This leads to considerable complexity in terms of production engineering and to high production costs. Since prepolymers with different chemical structures are needed in each case for the different applications, each end product has to be freed from the monomeric isocyanates individually. For MDI, only polyether-based products can be obtained by distillation at present, so it is not even possible to serve all applications.

For this reason, WO 2001/040342 describes a two-step method for the production of polyurethane compositions with a low content of monomeric diisocyanates. In a first step of this method, a diol component with a molecular weight of less than 2000 is reacted with a monomeric diisocyanate with a molecular weight of less than 500. The unreacted monomeric diisocyanate is removed from this reaction product, e.g. by distillation. The high molecular weight, low-monomer diisocyanate thus obtained can then be reacted virtually as a universal isocyanate component with additional polyol in a second stage, so that a reactive prepolymer with isocyanate end groups is formed. According to this document, polyurethane compositions of this type are suitable for use as binders for reactive one- or two-component adhesives/sealants, which may optionally comprise solvents, and in addition, with appropriate selection of the polyols, these compositions are said to be suitable for the production of reactive hot-melt adhesives. It is a disadvantage here too that a costly separation step (e.g. distillation) has to be performed to produce the high molecular weight low-monomer diisocyanate, leading to high production costs. Moreover, there are severe limitations with regard to the possible NCO content of this intermediate. In the case of the diisocyanate MDI, which is very important industrially, e.g. for reactive adhesives and sealants, the following must be considered, for example: if in the first step the lowest molecular weight diol available, ethylene glycol (molar mass 62 g/mol), is used and no chain extension is carried out, i.e. the reaction is conducted with an infinite excess of MDI, a product is obtained with an NCO content of 14.95 wt. %. This value virtually represents the upper limit of the NCO content that is theoretically achievable. In practice, the first step is carried out with a 5- to 10-fold MDI excess. With higher excesses, too much unreacted monomeric diisocyanate remains in the product at the end of the reaction and this has to be distilled off. On the one hand this is uneconomical and on the other hand the long distillation period that is then necessary leads to product damage as a result of undesirable secondary reactions (e.g. viscosity increase, higher residual monomer content). If the reaction of the ethylene glycol is carried out with a technically meaningful 5- to 10-fold MDI excess, a product with an NCO content of approx. 13-14 wt. % can be produced. This virtually represents the technically achievable upper limit for the NCO content of the first step. In addition, these intermediates have high viscosities or, as in the case of ethylene glycol, are even solids at ambient temperature. This makes them difficult to handle. The end products produced in the second step also have significantly higher viscosities than prepolymers produced in a direct, one-step method. As a result, their use is also limited.

Another possible way of producing low-monomer prepolymers consists in the use of so-called asymmetric diisocyanates. These are diisocyanates with NCO groups of differing reactivity.

Thus, for example, prepolymers carrying NCO end groups are known from WO 1993/009158, which preferably comprise 2,4-TDI, MDI with at least 90 wt. % 2,4′-MDI and/or IPDI as the isocyanate component. It can be taken from the examples that, while it is true that the products have low contents of monomeric diisocyanates (<1 wt. %), however, because of the low NCO/OH ratio (index) that is needed for this, the viscosities of these prepolymers are extremely high. For instance, the 2,4′-MDI-based prepolymers (examples B and D) have viscosities greater than 80000 mPas at 50° C. Products of this type are of only limited use owing to their high viscosities. Another disadvantage consists in the fact that 2,4′-MDI is present as a solid at ambient temperature and at this temperature it exhibits a high dimerisation rate, which leads to poor storage stability. 2,4′-MDI therefore has to be stored and transported under deep-frozen conditions. This is disadvantageous and leads to high logistics costs.

In WO 2003/006521, low-monomer prepolymers comprising NCO groups are described, which can be produced by reaction of asymmetric diisocyanates and polyols with molecular weights 2000 g/mol. As an example of the asymmetric diisocyanates, MDI with 2,4′-MDI contents greater than 97.5 wt. % are mentioned. During the reaction, the ratio of isocyanate groups to hydroxyl groups (index) is said to lie within the range of 1.05:1 to 2.0:1 and, according to the first claim, the end products have NCO contents of between 4 and 12 wt. %. Through the use of the short-chain polyols and of the index <2, these products are very highly viscous, particularly at low temperatures, and as a result are severely limited in their use. Here too, there is the problem for the manufacturer that the monomeric 2,4′-MDI has to be stored and transported under deep frozen conditions to prevent dimerisation. In example 2, the reaction of the prepolymer described above with other polyols (polyester polyol) to form an end product comprising NCO groups is described. However, these are also very highly viscous or solid at ambient temperature and thus, with the exception of hot-melt adhesives, practically unusable.

WO 2003/055929 describes prepolymers comprising NCO groups and the production thereof, in which a mixture of asymmetric diisocyanates, preferably 2,4′-MDI, and high molecular weight low-monomer diisocyanates is used as the isocyanate component. The high molecular weight low-monomer diisocyanates can be produced for example according to the teaching of the above-mentioned WO 01/40342, i.e. the production necessarily comprises a technically complex and therefore disadvantageous stage to separate off monomeric diisocyanates (e.g. distillation).

WO 2003/051951 discloses a two-step method for the production of low-monomer and low-viscosity prepolymers, in which an asymmetric diisocyanate is first reacted with a polyol having an average molecular weight of 60-3000 g/mol in a ratio of isocyanate groups to hydroxyl groups (index) in the range of 1.2:1 to 4:1 with the compulsory use of a catalyst to form an NCO functional prepolymer. This is then reacted in a second synthesis step with at least one other polyol. In the examples, only TDI and IPDI are used, while products based on 2,4′-MDI are not described. The only comparative example that is not according to the invention (example 5), in which the two-step method was carried out without the use of a catalyst, shows that, in comparison with the associated example 4 with the use of a catalyst, although a reduction in the residual monomer content from 0.55 wt. % to 0.03 wt. % is achieved with the method according to the invention, the viscosity increases dramatically at the same time. While the prepolymer of the comparative example (example 5) has a viscosity of 3250 mPas at 40° C., the product according to the invention from example 4 has a viscosity of approx. 30000 mPas at 40° C., which is higher by a factor of 10. In other words, the 2-step method described in this application is not suitable to provide prepolymers with a reduced content of monomeric diisocyanates at the same time as low viscosity. No comparison with a one-step direct production of the prepolymers is shown there.

WO 2003/033562 describes reactive adhesive compositions based on 2,4′-MDI which are solid at ambient temperature. These are practically unusable except as hot melt adhesives.

Here too, the producer has the problem that the monomeric 2,4′-MDI has to be stored and transported under deep frozen conditions to prevent dimerisation.

DE-C 16 18 380 describes a method for the production of an MDI derivative which is liquid at ambient temperature, characterised in that 4,4′-MDI and/or 2,4′-MDI is/are reacted with tripropylene glycol or short-chain polyether polyols having molar masses <700 g/mol. However, no such product based on 2,4′-MDI is available on the market.

Despite the prior art, the need still exists for polyurethanes carrying reactive NCO end groups with a reduced content of monomeric diisocyanates but which, at the same time, also have low viscosities and are therefore suitable for a broad range of applications and, in addition, are simple to process, particularly at ambient temperature.

Surprisingly, it has now been found that polyurethanes carrying reactive NCO end groups with a low content of monomeric diisocyanates and, at the same time, with low viscosities can be produced by producing them not directly, i.e. in one step (cf. comparative example 2), but in a two-step method (cf. example 1). For this purpose, in a first step, 2,4′-MDI is reacted with short-chain polyols in a ratio of isocyanate groups to hydroxyl groups (index) of greater than 4:1. The liquid intermediate thus obtained has good storage stability at ambient temperature and is simple to transport and handle. This intermediate is reacted with other polyols directly or at a later point in time to form the actual end product.

The present invention therefore provides a method for the production of reactive 2,4′-MDI based prepolymers carrying NCO end groups having a reduced content of monomeric diisocyanates and at the same time low viscosities, characterised in that
A) in a first synthesis step an NCO-terminated prepolymer which is liquid at ambient temperature having an NCO content >15 wt. % is produced by reaction of
   a1) 2,4′-MDI having a content of at least 95 wt. % of the 2,4′ isomer with
   a2) at least one diol having a molar mass of 62 g/mol to 700 g/mol or
   a mixture of mono- and/or di- and/or polyfunctional OH-functional components having an average functionality of ≧2.0 and a number average molar mass ≦700 g/mol
   a3) in a ratio of isocyanate groups to hydroxyl groups (index) of greater than 4:1
   a4) optionally using a catalyst and
B) in a second synthesis step, directly or at a later point in time, the
   b1) prepolymer produced in the first synthesis step A), which is liquid at ambient temperature, is reacted with
   b2) other polyols

to form the polyurethane carrying reactive NCO end groups having a reduced content of monomeric diisocyanates with, at the same time, reduced viscosity. The viscosity of the prepolymers according to the invention is low, so that good handling characteristics are present. It is preferably less than 30 000 mPas and particularly preferably less than 25 000 mPas, determined at 40° C. with the aid of the Physika MCR 51 rheometer from Anton Paar, Ostfildern, Del. at a shear rate of 40 l/s.

The prepolymer that is liquid at ambient temperature produced in the first synthesis step A) has an NCO content of 15.0 to 28.0 wt. %, preferably of 18.0 to 26.0 wt. % and particularly preferably of 21.5 to 25.0 wt. % .

The 2,4′-MDI a1) used in the first synthesis step A) has a content of the 2,4′ isomer of greater than 95 wt. %, preferably greater than 97 wt. % and particularly preferably greater than 98 wt. %.

The 2,4′-MDI a1) used in the first synthesis step A) has a content of the 2,2′ isomer of less than 1 wt. %, preferably less than 0.5 wt. % and particularly preferably less than 0.3 wt. %.

As diol a2) in the first synthesis step A), for example short-chain difunctional alcohols can be used. These are known per se to the person skilled in the art from polyurethane chemistry. For example, ethylene glycol, 1,2-propanediol, 1,3-propanediol, 1,2-butanediol, 1,3-butanediol, 1,4-butanediol and/or tripropylene glycol can be used.

Tripropylene glycol is used as a preferred short-chain difunctional alcohol.

As diol a2) in the first synthesis step A), for example difunctional polyether polyols can also be used. These are also known per se to the person skilled in the art from polyurethane chemistry. These are typically obtained starting from low molecular weight difunctional OH- or NH-functional compounds as starters by reaction with cyclic ethers or mixtures of different cyclic ethers. As catalysts here, bases such as KOH or double metal cyanide-based systems are used. Suitable production methods for this purpose are known per se to the person skilled in the art, e.g. from US-B 6 486 361 or L.E. St. Pierre, Polyethers Part I, Polyalkylene Oxide and other Polyethers, Editor: Norman G. Gaylord; High Polymers Vol. XIII; Interscience Publishers; Newark 1963; pp. 130 ff.

Suitable starters have 2 hydrogen atoms that are capable of polyaddition with cyclic ethers. Compounds of this type are e.g. water, ethylene glycol, 1,2- or 1,3-propylene glycol, 1,3-butanediol, 1,4-butanediol, 1,6-hexanediol, bisphenol A and neopentyl glycol.

As cyclic ethers, alkylene oxides such as ethylene oxide, propylene oxide, butylene oxide, epichlorohydrin or styrene oxide or tetrahydrofuran are suitable.

Preferably in A), polyethers a2) based on the above-mentioned starters with propylene oxide, ethylene oxide and/or tetrahydrofuran units, particularly preferably with propylene oxide and/or ethylene oxide units and most particularly preferably with propylene oxide units are used.

The difunctional polyethers a2) used in the first synthesis step A) have molar masses of less than 700 g/mol, preferably less than 500 g/mol and particularly preferably of 200 to 300 g/mol.

The monofunctional alcohols of the mixture of mono- and/or di- and/or polyfunctional OH-functional components a2) in the first synthesis step A) are known per se to the person skilled in the art from polyurethane chemistry. For example, methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, such as for example diethylene glycol monobutyl ether, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol can be used.

The polyfunctional alcohols for the mixture of mono- and/or di- and/or polyfunctional OH-functional components a2) in the first synthesis step A) are known per se to the person skilled in the art from polyurethane chemistry. For example, glycerol, trimethylolethane, trimethylolpropane, ditrimethylolpropane, butanetriol, pentaerythritol, dipentaerythritol, sorbitol and mannitol can be used.

As di- and/or polyfunctional OH-functional components in the mixture of mono- and/or di- and/or polyfunctional OH-functional components a2) in the first synthesis step A), for example the di- or polyfunctional polyether polyols that are known per se to the person skilled in the art can be used. They are typically obtained starting from low molecular weight polyfunctional OH- or NH-functional compounds as starter by reaction with cyclic ethers or mixtures of different cyclic ethers. As catalysts here, bases such as KOH or double metal cyanide-based systems are used. Suitable production methods for this purpose are known per se to the person skilled in the art, e.g. from U.S. Pat. No. 6,486,361 or L. E. St. Pierre, Polyethers Part I, Polyalkylene Oxide and other Polyethers, Editor: Norman G. Gaylord; High Polymers Vol. XIII; Interscience Publishers; Newark 1963; pp. 130 ff.

Suitable starters preferably have 2-8, particularly preferably 2-6 hydrogen atoms that are capable of polyaddition with cyclic ethers. Compounds of this type are for example water, ethylene glycol, 1,2- or 1,3-propylene glycol, 1,3-butanediol, 1,4-butanediol, 1,6-hexanediol, bisphenol A, neopentyl glycol, glycerol, trimethylolpropane, pentaerythritol, sorbitol.

Suitable as cyclic ethers are alkylene oxides, such as ethylene oxide, propylene oxide, butylene oxide, epichlorohydrin or styrene oxide or tetrahydrofuran.

Preferably, polyethers based on the above-mentioned starters with propylene oxide, ethylene oxide and/or tetrahydrofuran units, particularly preferably with propylene oxide and/or ethylene oxide units, are used as di- and/or polyfunctional OH-functional components a2) in the first synthesis step A).

As polyols b2) in the second synthesis step B), for example the polyether polyols and/or polycarbonate polyols and/or polyester polyols and/or OH-functional polybutadienes known per se to the person skilled in the art from polyurethane chemistry are suitable.

The polyether polyols that are suitable as polyols b2) in the second synthesis step B) are known per se to the person skilled in the art from polyurethane chemistry. They are typically obtained starting from low molecular weight polyfunctional OH- or NH-functional compounds as starter by reaction with cyclic ethers or mixtures of different cyclic ethers. As catalysts here, bases such as KOH or double metal cyanide-based systems are used. Production methods that are suitable for this purpose are known per se to the person skilled in the art, e.g. from U.S. Pat. No. 6,486,361 or L. E. St. Pierre, Polyethers Part I, Polyalkylene Oxide and other Polyethers, Editor: Norman G. Gaylord; High Polymers Vol. XIII; Interscience Publishers; Newark 1963; pp. 130 ff.

Suitable starters preferably have 2-8, particularly preferably 2-6 hydrogen atoms that are capable of polyaddition with cyclic ethers. Compounds of this type are e.g. water, ethylene glycol, 1,2- or 1,3-propylene glycol, 1,3-butanediol, 1,4-butanediol, 1,6-hexanediol, bisphenol A, neopentyl glycol, glycerol, trimethylolpropane, pentaerythritol, sorbitol.

Suitable as cyclic ethers are alkylene oxides, such as ethylene oxide, propylene oxide, butylene oxide, epichlorohydrin or styrene oxide or tetrahydrofuran.

As polyols b2) in the second synthesis step B), polyethers preferably based on the above-mentioned starters with propylene oxide, ethylene oxide and/or tetrahydrofuran units and particularly preferably with propylene oxide and/or ethylene oxide units are preferably used.

It is, of course, also possible to use polyethers comprising fillers as polyols b2) in the second synthesis step B). These are known per se to the person skilled in the art from polyurethane chemistry. Examples are styrene-acrylonitrile (SAN) or polyurea (PHD) as polyethers comprising filler, which are marketed e.g. by Bayer MaterialScience AG, Leverkusen, Del.

The polycarbonate polyols that are suitable as polyols b2) in the second synthesis step B), which are substantially linear and have at least two, preferably terminal OH groups, can be obtained for example by the reaction of diols, such as propylene glycol, 1,4-butanediol or 1,6-hexanediol, diethylene glycol, triethylene glycol or tetraethylene glycol or mixtures of two or more thereof with diaryl carbonates, for example diphenyl carbonate, or phosgene.

The polyester polyols that are suitable as polyols b2) in the second synthesis step B) are known per se to the person skilled in the art from polyurethane chemistry and have a molecular weight of about 200 to about 10 000 g/mol and preferably of about 1000 to about 6000 g/mol. Thus, for example, polyester polyols can be used which are formed by reaction of low molecular weight alcohols, in particular of ethylene glycol, diethylene glycol, neopentyl glycol, hexanediol, butanediol, propylene glycol, glycerol or trimethylolpropane with caprolactone. Also suitable as polyfunctional alcohols for the production of polyester polyols are 1,4-hydroxymethylcyclohexane, 2-methyl-1,3-propanediol, 1,2,4-butanetriol, triethylene glycol, tetraethylene glycol, polyethylene glycol, dipropylene glycol, poly-propylene glycol, dibutylene glycol and polybutylene glycol.

Other suitable polyester polyols can be produced by polycondensation. For instance, difunctional and/or trifunctional alcohols can be condensed with a substoichiometric quantity of dicarboxylic acids and/or tricarboxylic acids, or reactive derivatives thereof, to form polyester polyols. Suitable dicarboxylic acids are, for example, adipic acid or succinic acid and higher homologues thereof with up to 16 C atoms, and also unsaturated dicarboxylic acids, such as maleic acid or fumaric acid, as well as aromatic dicarboxylic acids, in particular the isomeric phthalic acids, such as phthalic acid, isophthalic acid or terephthalic acid. Suitable as tricarboxylic acids are, for example, citric acid or trimellitic acid. The aforementioned acids can be used individually or as mixtures of two or more thereof. Particularly suitable alcohols are hexanediol, butanediol, ethylene glycol, diethylene glycol, neopentyl glycol, 3-hydroxy-2,2-dimethylpropyl 3-hydroxy-2,2-dimethylpropanoate or trimethylolpropane or mixtures of two or more thereof. Particularly suitable acids are phthalic acid, isophthalic acid, terephthalic acid, adipic acid or dodecanedioic acid or mixtures thereof.

Polyester polyols with high molecular weight include, for example, the reaction products of polyfunctional, preferably difunctional, alcohols (optionally together with small quantities of trifunctional alcohols) and polyfunctional, preferably difunctional, carboxylic acids.

Instead of free polycarboxylic acids, (if possible) the corresponding polycarboxylic anhydrides or corresponding polycarboxylic acid esters with alcohols having preferably 1 to 3 C atoms can also be used. The polycarboxylic acids can be aliphatic, cycloaliphatic, aromatic or heterocyclic or both. They may optionally be substituted, for example by alkyl groups, alkenyl groups, ether groups or halogens. Suitable as polycarboxylic acids are, for example, succinic acid, adipic acid, suberic acid, azelaic acid, sebacic acid, dodecanedioic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acid or trimer fatty acid or mixtures of two or more thereof.

Polyesters obtainable from lactones, for example based on ε-caprolactone, also known as “polycaprolactones”, or hydroxycarboxylic acids, for example ω-hydroxycaproic acid, can also be used.

However, polyester polyols of oleochemical origin can also be employed. These polyester polyols can be produced e.g. by complete ring opening of epoxidised triglycerides of an at least partially olefinically unsaturated fatty acid-comprising fat mixture with one or more alcohols having 1 to 12 C atoms and subsequent partial transesterification of the triglyceride derivatives to form alkyl ester polyols having 1 to 12 C atoms in the alkyl residue.

Polyesters comprising fillers can, of course, also be used as polyols b2) in the second synthesis step B). These are known per se to the person skilled in the art from polyurethane chemistry.

The OH-functional polybutadienes that are suitable as polyols b2) in the second synthesis step B) are known per se to the person skilled in the art from polyurethane chemistry and are marketed e.g. with the name “Poly-bd”. They are used e.g. when the prepolymers should exhibit particularly hydrophobic properties. Binders for bitumen blends for seam sealers for flat roofs may be mentioned as an example of an application.

The production of the polyurethane prepolymers having NCO end groups takes place in a manner that is known from polyurethane chemistry.

The production takes place in a two-step method. In the first synthesis step A) thereof, the polyol a2) or a mixture of the polyols a2) is mixed with an excess of the isocyanate component a1) and the homogeneous mixture is stirred until a constant NCO value is obtained. A reaction temperature of 50° C. to 120° C., preferably 50° C. to 100° C., is selected. Both reactants are preferably liquid at the selected reaction temperature, so that it is not necessary to use additional solvents to homogenise and reduce the viscosity of the reaction mixture.

The prepolymer produced in the first synthesis step A) is liquid at ambient temperature and can either be further reacted immediately in a second synthesis step B) or is packed into suitable containers and further reacted in a second synthesis step B) at a later point in time.

In the second synthesis step B), the polyol b2) or a mixture of the polyols b2) is mixed with an excess of the prepolymer b1) produced in the first synthesis step A) and the homogeneous mixture is stirred until a constant NCO value is obtained. A reaction temperature of 50° C. to 120° C., preferably 50° C. to 100° C., is selected. The polyol or polyols as well as the reaction product are preferably liquid at the selected reaction temperature, so that it is not necessary to use additional solvents to homogenise and reduce the viscosity of the reaction mixture.

For the production of reactive polyurethane hot melt adhesives (PUR hotmelts), reaction temperatures of 120-180° C. and preferably 130-150° C. are used in the second synthesis step B).

The two-step method or one of the two synthesis steps for the production of the polyurethane prepolymers having NCO end groups can of course also take place continuously in a stirred vessel cascade or suitable mixing equipment, such as e.g. high-speed mixers according to the rotor-stator principle.

The NCO content is determined by an NCO titrimetric method which is conventional in polyurethane chemistry.

If desired, catalysts to accelerate the NCO/OH reaction and/or solvents may optionally be added during prepolymer production.

Suitable as catalysts are the amine or organometallic compounds known per se from polyurethane chemistry.

For example, the following compounds can be used as catalysts: triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- and N-ethylmorpholine, N,N′-dimorpholinodiethyl ether (DMDEE), N-cyclohexylmorpholine, N,N,N′,N′-tetramethylethylenediamine, N,N,N′,N′-tetramethylbutanediamine, N,N,N′,N′-tetramethyl-1,6-hexanediamine, pentamethyldiethylenetriamine, dimethylpiperazine, N-dimethylaminoethylpiperidine, 1,2-dimethylimidazole, N-hydroxypropylimidazole, 1-azabicyclo-[2.2.0]-octane, 1,4-diazabicyclo-[2.2.2]-octane (Dabco) and alkanolamine compounds, such as triethanolamine, triisopropanolamine, N-methyl- and N-ethyl-diethanolamine, dimethylaminoethanol, 2-(N,N-dimethylaminoethoxy)ethanol, N,N′,N-tris-(dialkylaminoalkyl)hexahydrotriazines, e.g. N,N′,N-tris(dimethylaminopropyl)-s-hexa-hydrotriazine, iron(II) chloride, zinc chloride, lead octoate and preferably tin salts, such as tin dioctoate, tin diethylhexoate, dibutyltin dilaurate and/or dibutyldilauryltin mercaptide, 2,3-dimethyl-3,4,5,6-tetrahydropyrimidine, tetraalkylammonium hydroxides, such as tetramethylammonium hydroxide, alkali hydroxides, such as sodium hydroxide, alkali alcoholates, such as sodium methylate and potassium isopropylate and/or alkali salts of long-chain fatty acids having 10 to 20 carbon atoms and optionally lateral OH groups. Ti compounds, in particular Ti(IV)-O-alkyl compounds, with alkyl groups such as methyl, ethyl, n-propyl, isopropyl, n-butyl, isobutyl, tert.-butyl, n-pentyl, 2-pentyl, 3-pentyl, preferably ethyl, n-propyl, isopropyl, n-butyl, isobutyl, tert.-butyl and particularly preferably Ti(IV) butylate, have additionally proved suitable as catalysts.

Also suitable are e.g. the organometallic compounds of tin, lead, iron, titanium, bismuth or zirconium, such as tetraisopropyl titanate, lead phenylethyl dithiocarbaminate, tin(II) salts of carboxylic acids, e.g. tin-II acetate, ethylhexoate and diethylhexoate. Another class of compounds is represented by the dialkyltin(IV) carboxylates. The carboxylic acids have 2, preferably at least 10, in particular 14 to 32 C atoms. Dicarboxylic acids can also be used. The following may be explicitly mentioned as acids: adipic acid, maleic acid, fumaric acid, malonic acid, succinic acid, pimelic acid, terephthalic acid, phenylacetic acid, benzoic acid, acetic acid, propionic acid as well as 2-ethylhexanoic, caprylic, capric, lauric, myristic, palmitic and stearic acid.

Tin oxides and sulfides as well as tin thiolates can also be used. Specific compounds are: bis(tributyltin) oxide, bis(trioctyltin) oxide, dibutyl- and dioctyltin bis(2-ethylhexylthiolate) dibutyl- and dioctyltin didodecylthiolate, bis(β-methoxycarbonylethyl)tin didodecylthiolate, bis(β-acetylethyl)tin bis(2-ethylhexylthiolate), dibutyl- and dioctyltin didodecylthiolate, butyl- and octyltin tris(thioglycolic acid 2-ethylhexoate), dibutyl- and dioctyltin bis(thioglycolic acid 2-ethylhexoate), tributyl- and trioctyltin (thioglycolic acid 2-ethylhexoate) and butyl- and octyltin tris(thioethylene glycol 2-ethylhexoate), dibutyl- and dioctyltin bis(thioethylene glycol 2-ethylhexoate), tributyl- and trioctyltin (thioethylene glycol 2-ethylhexoate) with the general formula Rₙ₊₁Sn(SCH₂CH₂OCOC₈H₁₇)₃₋₁, wherein R is an alkyl group with 4 to 8 C atoms, bis(β-methoxycarbonylethyl)tin bis(thioethylene glycol 2-ethylhexoate), bis(β-methoxycarbonylethyl)tin bis(thioglycolic acid 2-ethylhexoate) and bis(β-acetylethylnin bis(thioethylene glycol 2-ethylhexoate) and bis(β-acetylethylnin bis(thioglycolic acid-2-ethylhexoate).

Bismuth carboxylates in particular are used as organobismuth compounds, wherein the carboxylic acids possess 2 to 20 C atoms, preferably 4 to 14 atoms. The following may be mentioned explicitly as acids: butyric acid, caproic acid, caprylic acid, capric acid, lauric acid, myristic acid, palmitic acid, stearic acid, arachidic acid, isobutyric acid and 2-ethylhexanoic acid. It is also possible to use mixtures of bismuth carboxylates with other metal carboxylates, for example tin carboxylates.

If prepolymers with a particularly low residual content of free MDI monomer at the same time as low viscosity are to be produced, the use of catalysts is preferred, with organometallic compounds being particularly preferably used.

If catalysts are employed, the quantity thereof, based on the total quantity of the components a1) and a2) to be reacted in the first synthesis step, is 0.01 to 8 wt. %, preferably 0.05 to 5 wt. % and particularly preferably 0.1 to 3 wt. %.

Preferred organometallic catalysts are those from the group of the tin(IV) compounds.

Preferred catalysts from the group of the tin(IV) compounds are dibutyl- and dioctyltin diacetate, maleate, bis(2-ethylhexoate), dilaurate, dichloride, bisdodecyl mercaptide, tributyltin acetate, bis(β-methoxycarbonylethyl)tin dilaurate and bis(β-acetylethyl)tin dilaurate.

Dibutyltin dilaurate is most particularly preferred as an organometallic catalyst.

To stop the reaction, a mineral or organic acid, such as hydrochloric acid, sulfuric acid, phosphoric acid or derivatives thereof, formic acid, acetic acid or another alkanoic or organic acid or an acid-releasing component, such as for instance acid halides, may optionally be added. Examples of suitable acid chlorides are formyl chloride, acetyl chloride, propionyl chloride, isophthaloyl dichloride, terephthaloyl dichloride and benzoyl chloride. The stopping of the reaction is particularly advantageous if one of the above-mentioned known amine or organometallic catalysts was employed during the production of the prepolymer.

The products that are obtainable according to the invention preferably have residual monomer contents of methylene diphenyl diisocyanates of less than 1.0 wt. %, particularly preferably less than 0.3 wt. % and most particularly preferably less than 0.1 wt. %, based on the solvent-free NCO-functional prepolymer.

Examples of applications for the polyurethane prepolymers according to the invention are their use in PUR foams, coating compositions, lacquers, paints, adhesives, laminating materials, sealants, printing inks, inks, colouring agents, dyes, mordants, anticorrosive and anti-rust agents, impregnating agents and graphic materials, for the production of wound dressing materials and incontinence products, for the production of pharmaceutical formulations, as lubricants, slip agents, mould release agents or coolants, in fuels, as oil, in and as thinners, cleaning agents and pretreatment agents.

The invention also provides polyurethane plastics, coatings, bonds, seals, encapsulating compounds, printed products, composite films, wound dressing materials, incontinence products, pharmaceutical products, lubricants, slip agents, mould release agents or coolants, fuels, oils, thinners, cleaning agents and pretreatment agents and foams produced using the prepolymers that are obtainable according to the invention.

Depending on the molecular weight and nature of the polyol components selected, these isocyanate reaction products can be present in liquid or solid form at ambient temperature. It is also possible for the isocyanate functional prepolymers to be dissolved in inert organic solvents.

The isocyanate functional prepolymers according to the invention can be used directly as crosslinking components in reactive PU compositions, for example in 1-pack or 2-pack PU compositions, or they are reacted in further reaction stages with suitable compounds, for example the polyols listed above, which can react with the NCO groups. These PU prepolymers can then be used e.g. in the above-mentioned PU compositions.

The PU compositions comprising the isocyanate functional prepolymers according to the invention can also comprise other additives. These can be e.g. catalysts, resins, solvents, pigments, stabilisers, adhesion promoters, dyes, flow control agents, plasticisers, fillers, thixotropic agents, drying agents and similar auxiliary substances. These can be selected by the person skilled in the art according to the intended application.

Suitable as catalysts to accelerate curing are, for example, tertiary amines which are not incorporated into the prepolymer chain, such as diazabicyclooctane (Dabco), triethylamine, dimethylbenzylamine (Desmorapid® DB, Bayer MaterialScience AG, Leverkusen, Del.), bisdimethylaminoethyl ether, tetramethylguanidine, bisdimethylaminomethylphenol, 2,2′-dimorpholinodiethyl ether, 2-(2-dimethylaminoethoxy)ethanol, 2-dimethylaminoethyl-3-dimethylaminopropyl ether, bis(2-dimethylaminoethyl) ether, N,N-dimethylpiperazine, N-(2-hydroxyethoxyethyl)-2-azanorborane, N,N,N′,N′-tetramethyl-1,3-butanediamine, N,N,N′,N′-tetramethyl-1,3-propanediamine or N,N,N′,N′-tetramethyl-1,6-hexanediamine or any mixtures of more than one of the above-mentioned compounds.

The catalysts can also be present in oligomerised or polymerised form, e.g. as N-methylated polyethyleneimine.

Also suitable as catalysts are 1-methylimidazole, 2-methyl-l-vinylimidazole, 1-allylimidazole, 1-phenylimidazole, 1,2,4,5-tetramethylimidazole, 1-(3-aminopropyl)imidazole, pyrimidazole, 4-dimethylaminopyridine, 4-pyrrolidinopyridine, 4-morpholino-pyridine, 4-methylpyridine or N-dodecyl-2-methylimidazole or any mixtures of more than one of the above-mentioned compounds.

In addition to or instead of the tertiary amines, organometallic compounds, such as organotin compounds of carboxylic acids, strong bases, such as alkali hydroxides, alcoholates and phenolates, e.g. di-n-octyltin mercaptide, dibutyltin maleate, diacetate, dilaurate, dichloride, bisdodecyl mercaptide, tin-II acetate, ethylhexoate and diethylhexoate or lead phenylethyldithiocarbaminate can also be comprised in moisture-curing PUR sealants of this type.

As tackifying resins it is possible to use e.g. abietic acid, abietic acid esters, terpene resins, terpene phenolic resins, phenol-modified styrene polymers, phenol-modified a-methylstyrene polymers or hydrocarbon resins.

Solvent naphtha, xylene, ethyl acetate, butyl acetate, methoxypropyl acetate and methyl ethyl ketone may be mentioned as examples of solvents.

As antioxidants, for example the commercial sterically hindered phenols and/or thio ethers and/or substituted benzotriazoles or the sterically hindered amines of the HALS type can be used.

As adhesion promoters, for example the known functional silanes are used, such as for example aminosilanes of the above-mentioned type but also N-aminoethyl-3-aminopropyl-trimethoxy and/or N-aminoethyl-3-aminopropylmethyldimethoxysilane, epoxysilanes and/or mercaptosilanes.

Phthalic acid esters, adipic acid esters, alkylsulfonic acid esters of phenol or phosphoric acid esters may be mentioned as examples of suitable plasticisers.

Carbon black, precipitated silicas, pyrogenic silicas, mineral chalks and precipitated chalks may be mentioned as examples of suitable fillers.

Pyrogenic silicas, polyamides, hydrogenated castor oil derivatives or polyvinyl chloride may be mentioned as examples of thixotropic agents.

Alkoxysilyl compounds, such as vinyltrimethoxysilane, methyltrimethoxysilane, i-butyl-trimethoxysilane, hexadecyltrimethoxysilane, and inorganic substances, such as e.g. calcium oxide (CaO) (may also act as a CO₂ scavenger), and compounds carrying isocyanate groups, such as e.g. tosyl isocyanate, may be mentioned as examples of drying agents.

The invention is explained below by means of examples.

### EXAMPLES

Unless indicated otherwise, all percentages relate to percentages by weight.

The viscosities were determined at a measuring temperature of 40° C. with the aid of a Physika MCR 51 rheometer from Anton Paar, Ostfildern, Del. at a shear rate of 40 l/s.

The determination of the NCO content of the prepolymers and reaction mixtures respectively took place in accordance with DIN EN 1242.

The determination of the residual monomer content of the prepolymers and reaction mixtures respectively took place by means of gel permeation chromatography (GPC): Pump, injector and refractive index detector (RI): Hewlett Packard 1100 Series II; column oven: LaChrom L-7350 (Merck); separating columns: 1×Nucleogel precolumn and 4×Nucleogel SDV separating columns 300 mm×7.7 mm; mobile phase: tetrahydrofuran (THF); flow rate: 0.6 ml/min; temperature: 30° C.; injection volume: 40 μl; samples dissolved in THF.

Polyether A:

Polyether polyol with a nominal functionality of 2 and a hydroxyl number of 515 mg KOH/g, produced by propoxylation of propylene glycol

Polyether B:

Polyether polyol with a nominal functionality of 2 and a hydroxyl number of 260 mg KOH/g, produced by propoxylation of propylene glycol

Polyether C:

Polypropylene glycol produced by the Impact® method using DMC catalysis with a nominal functionality of 2 and a hydroxyl number of approx. 28 mg KOH/g (Acclaim® 4200 from Bayer MaterialScience AG, Leverkusen, Del.).

Diisocyanate I:

2,4′-Diphenylmethane diisocyanate with the following MDI isomer composition (balance: indefinable impurities):

At least 98% 2,4′-diphenylmethane diisocyanate

Maximum 1.5% 4,4′-diphenylmethane diisocyanate

Maximum 0.3% 2,2′-diphenylmethane diisocyanate

### Example 1 (According to the Invention)

1st step: Production of the Modified 2,4′-MDI which is Liquid at Ambient Temperature

In a heatable and coolable glass flask, which was provided with a stirrer and a dropping funnel, 1279.62 g (5.12 mol) diisocyanate I were melted at a temperature of 80° C. To the molten diisocyanate were added, with stirring, 220.38 g (1.01 mol) of the polyether A, which had previously been dehydrated at a temperature of 120° C. and under a vacuum of <20 mbar, in such a way that the temperature remained constant in a range of 80-85° C. The reaction mixture was then stirred further at 80° C. until a constant NCO content of 23.0% (theoretical value: 23.0%) was reached. The product was then poured off. The product from the first step is difunctional and has a urethane group concentration of 1.35 mol urethane groups/kg (calculation: 2.02 mol OH groups of the polyol are converted quantitatively to urethane groups=2.02 mol urethane groups per 1500 g solid=1.35 mol urethane groups/kg).

2nd step: Production of the End Product

In a heatable and coolable glass flask, which was provided with a stirrer and a dropping funnel, 293.76 g (0.805 mol) of the prepolymer that was produced in the 1st step were initially charged at a temperature of 80° C. To this was added, with stirring, a mixture of 130.87 g (0.303 mol) polyether B and 575.37 g (0.144 mol) polyether C, which had previously been dehydrated at a temperature of 120° C. and under a vacuum of <20 mbar, in such a way that the temperature remained constant in a range of 80-85° C. After the complete addition of the polyether mixture, the reaction mixture was stirred further at 80° C. until after a reaction time of 6 hours a constant NCO content of 3.0% (theoretical value: 3.0%) was reached. The end product is difunctional, has a urethane group concentration of 1.29 mol urethane groups/kg (calculation: 293.76 g prepolymer from the 1st step comprise 1.35×0.29376=0.397 mol urethane groups. The 0.894 mol OH groups of the polyol mixture are converted quantitatively to urethane groups=0.894 mol urethane groups. In total, the reaction product from the 2nd step comprises 0.397+0.894=1.29 mol urethane groups per 1000 g solid=1.29 mol urethane groups/kg) and a viscosity of 24500 mPas at 40° C. The residual monomer content of free methylene diphenyl diisocyanate is 0.1%.

### Comparative Example 2 (Not According to the Invention)

Direct Production of the End Product:

In a heatable and coolable glass flask, which was provided with a stirrer and a dropping funnel, 375.75 g (1.503 mol) diisocyanate I were melted at a temperature of 80° C. To the molten diisocyanate was added, with stirring, a mixture of 74.73 g (0.343 mol) polyether A, 175.34 g (0.406 mol) polyether B and 874.18 g (0.218 mol) polyether C, which had previously been dehydrated at a temperature of 120° C. and under a vacuum of <20 mbar, in such a way that the temperature remained constant in a range of 80-85° C. After the complete addition of the polyether mixture, the reaction mixture was stirred further at 80° C. until after a reaction time of 8 hours a constant NCO content of 2.9% (theoretical value: 3.0%) was reached. The end product is difunctional, has a urethane group concentration of 1.29 mol urethane groups/kg (calculation: 1.934 mol OH groups of the polyol mixture are converted quantitatively to urethane groups=1.934 mol urethane groups per 1500 g solid =1.29 mol urethane groups/kg) and a viscosity of 32300 mPas at 40° C. The residual monomer content of free methylene diphenyl diisocyanate is 6.57%.

Discussion of Results:

As the examples show, the prepolymers produced by the two-step method according to the invention have significantly lower viscosity than prepolymers with the same functionality and the same urethane group concentration which were produced directly, i.e. in a one-step method. Moreover, the prepolymers produced by the two-step method according to the invention have significantly lower residual monomer contents of free methylene diphenyl diisocyanate than prepolymers with the same functionality and the same urethane group concentration which were produced directly, i.e. in a one-step method.

1-13. (canceled)

14. A method for the production of low-viscosity 2,4′-MDI based prepolymers carrying reactive NCO end groups having a reduced content of monomeric diisocyanates, comprising
A) producing, in a first synthesis step an NCO-terminated prepolymer which is liquid at ambient temperature having an NCO content >15 wt. % by reaction of
a1) 2,4′-MDI having a content of at least 95 wt. % of the 2,4′ isomer with
a2) at least one diol having a molar mass of 62 g/mol to 700 g/mol Or
a mixture of mono- and/or di- and/or polyfunctional OH-functional components having an average functionality of ≧2.0 and a number average molar mass ≦700 g/mol
a3) in a ratio of isocyanate groups to hydroxyl groups (index) of greater than 4:1
a4) optionally using a catalyst, and
B) reacting, in a second synthesis step, directly or at a later point in time, the
b1) prepolymer produced in the first synthesis step A), which is liquid at ambient temperature, with
b2) other polyols,
to form the polyurethane carrying reactive NCO end groups having a reduced content of monomeric diisocyanates with, at the same time, reduced viscosity.

15. The method according to claim 14, wherein the 2,4′-MDI (a1) in the first synthesis step (A) has a content of 2,4′-isomer greater than 95 wt. %.

16. The method according to claim 14, wherein the 2,4′-MDI (a1) in the first synthesis step (A) has a content of 2,4′-isomer greater than 97 wt. %.

17. The method according to claim 14, wherein the 2,4′-MDI (a1) in the first synthesis step (A) has a content of 2,4′-isomer greater than 98 wt. %.

18. The method according to claim 14, wherein the 2,4′-MDI (a1) in the first synthesis step (A) has a content of the 2,2′-isomer of less than 1 wt. %.

19. The method according to claim 14, wherein the 2,4′-MDI (a1) in the first synthesis step (A) has a content of the 2,2′-isomer of less than 0.5 wt. %.

20. The method according to claim 14, wherein the 2,4′-MDI (a1) in the first synthesis step (A) has a content of the 2,2′-isomer of less than 0.3 wt. %.

21. The method according to claim 14, wherein as diol (a2) in the first synthesis step (A), difunctional alcohols selected from the group consisting of ethylene glycol, 1,2-propanediol, 1,3-propanediol, 1,2-butanediol, 1,3-butanediol, 1,4-butanediol and/or tripropylene glycol are used.

22. The method according to claim 14, wherein as diol (a2) in the first synthesis step (A), tripropylene glycol is used as difunctional alcohol.

23. The method according to claim 14, wherein the difunctional polyethers (a2) in the first synthesis step (A) have molar masses of less than 700 g/mol.

24. The method according to claim 14, wherein in the second synthesis step (B), polyethers based on starters selected from the group consisting of water, ethylene glycol, 1,2- or 1,3-propylene glycol, 1,3-butanediol, 1,4-butanediol, 1,6-hexanediol, bisphenol A, neopentyl glycol, glycerol, trimethylolpropane, pentaerythritol and/or sorbitol with propylene oxide, ethylene oxide and/or tetrahydrofuran units are used as polyols (b2).

25. The method according to claim 14, wherein the second synthesis step (B) is carried out at reaction temperatures of 120-180° C.

26. A method comprising utilizing the prepolymer obtained according to claim 14 as a crosslinking component in the production of a reactive one- and two-component adhesive/sealant, a reactive hot-melt adhesive, a bonding foam, an encapsulating compound and a flexible, rigid and structural foam.
